(19) United States
(12) Patent Application Publication
(10) Pub. No.: US 2004/0213956 A1
(43) Pub. Date: Oct. 28, 2004

(54) Perforated film with liquid retention and gas/vapor venting characteristics for packaging

(75) Inventors: Herbert D. Stroud JR., Rutherfordton, NC (US); Melvin G. Mitchell, Penrose, NC (US)

Correspondence Address: Adams Evans P.A., 2180 Two Wachovia Center, 301 S. Tryon Street, Charlotte, NC, 28282, US

(73) Assignee: Rutherford Sales & Recovery Co., Inc., Forest City, NC

(21) Appl. No.: 10/827,793

(22) Filed: Apr. 20, 2004

Related U.S. Application Data
(60) Provisional application No. 60/465,741, filed on Apr. 25, 2003.

(51) Int. Cl. B32B 3/10

(52) U.S. Cl. 428/137; 428/131

(57) ABSTRACT

A process of forming a perforated packaging film with simultaneous liquid retention and gas/vapor venting characteristics, including the steps of forming a polyolefin film, perforating the film with perforations being either slits having a length of no more than 100 mils or holes having a diameter of no more than about 5 mils, and spacing the perforations from each other so that the total open orifice area is no greater than 20 mils/in².

### TECHNICAL FIELD AND BACKGROUND OF THE INVENTION

This application is based on and claims priority from Provisional Application No. 60/465,741, filed Apr. 25, 2003.

This application relates to film products for sealing containers such as food and medical products containers. Recent trends in eating habits focus on saving food preparation and cooking time. Prepared meals are available either partially or fully cooked in frozen or refrigerated form. The food is typically packaged in containers which are used for both freezing/refrigeration and cooking/reheating. These containers are sealed via the use of a polyolefin film lidding applied across the top of the structure and adhered to the tray, typically with a hot melt adhesive. The food container can be heated using a microwave oven, conventional oven, or convection oven. These ovens impart energy to the container and the food, producing heat and subsequent steam generation with rapid pressure build-up.

Previous solutions to the rapid build-up of steam pressure inside of these containers have been proposed. These solutions include incorporation of a relief port in the container that can be opened by removal of a seal prior to heating. The subject relief port can also be fitted with a seal which incorporates a mechanical or thermal pressure relief valve which opens during heating. An additional method incorporates the use of a low temperature-melt adhesive at some position in the seal of the film to the container which releases during heating and allows the lidding to lift off the container at that position during heating. Also, the end user can be advised to remove all or part of the film or create a hole in the container prior to heating.

### SUMMARY OF THE INVENTION

The present invention thus discloses polyolefin films which have numerous pressure relief ports (microperforations) formed into the web. The ports can be in the form of slits or holes created by a variety of microperforating techniques, including but not limited to mechanical, laser or electrostatic devices. The microperforated film is hermetically sealed to a suitable tray, pouch or container which contains liquid and/or solids. This microperforated film exhibits liquid retention while permitting gas/vapor venting though the web. This film also exhibits the properties of heat stability, strength and contamination barrier.

It has been found that slits into a hydrophobic film under the length of 100 mils will not routinely pass liquid due to the difference in surface energy of the film in relation to the liquid in the food at room or lower temperatures during the normal handling of the food package. Films which contain slits of smaller proportions (1-100 mils) are capable of adequately venting steam from food containers when heated by simply increasing the frequency of slits in the film as the port size becomes smaller.

It has also been found that a perforated hole will not ordinarily pass liquid through a hydrophobic film during normal handling if the holes are less than 5 mils in diameter.

An additional improvement in the preceding technique can be offered by coating the food or sealing one side of the film with an adhesive, such as a hot melt adhesive, after the microperforation step has been carried out. The adhesive coating will seal the slit or hole microperforation creating a better cold/ambient barrier yet still open and vent adequately upon heating. This film construction exhibits the best contamination and liquid barrier properties.

It is therefore an object of the invention to provide a process of manufacturing a microperforated film useful in covering food and medical containers.

It is another object of the invention to provide a microperforated film useful in covering food and medical containers.

These and other objects of the present invention are achieved in the preferred embodiments disclosed below by providing a process of forming a perforated packaging film with simultaneous liquid retention and gas/vapor venting characteristics, comprising the steps of forming a polyolefin film, perforating the film with perforations selected from the group of perforations consisting of slits having a length of no more than 100 mils and holes having a diameter of no more than about 5 mils, and spacing the perforations from each other so that the total open orifice area is no greater than 20 mils/in².

According to one embodiment of the invention, the film is selected from the group of polyolefins consisting of polypropylene (PP), polyethylene (PE), polyethylene terephthalate (PET), nylon 6 (N6), nylon 66 (N6,6), polytetrafluoroethylene (PTFE), polyvinylfluoride (PVF), polyvinylchloride (PVC), polyvinylidenefluoride (PVDF), and polyvinylidenechluoride (PVDC).

According to another embodiment of the invention, the process includes the step of coating the film with an adhesive layer after the film is perforated.

According to another embodiment of the invention, the process includes the steps of coating the film with an adhesive layer before the film is perforated, and perforating the film and the adhesive layer.

According to another embodiment of the invention, the adhesive is a hot melt adhesive.

According to another embodiment of the invention the film has a weight of between 17 g/m² (0.5 oz/yd²) and 102 g/m² (3.0 oz/yd²).

According to another embodiment of the invention film contains at least 80 percent by weight PET.

According to an embodiment of the product according to the invention, a perforated packaging film is provided with simultaneous liquid retention and gas/vapor venting characteristics, and comprises a polyolefin film having perforations selected from the group of perforations consisting of slits having a length of no more than 100 mils and holes having a diameter of no more than about 5 mils, wherein the perforations are spaced from each other so that the total open orifice area is no greater than 20 mils/in².

According to another embodiment of the invention, the film is selected from the group of polyolefins consisting of polypropylene (PP), polyethylene (PE), polyethylene terephthalate (PET), nylon 6 (N6), nylon 66 (N6,6), polytetrafluoroethylene (PTFE), polyvinylfluoride (PVF), polyvinylchloride (PVC), polyvinylidenefluoride (PVDF), and polyvinylidenechluoride (PVDC)

According to another embodiment of the invention, an adhesive layer is applied to the film.

According to another embodiment of the invention the adhesive is a hot melt adhesive.

According to another embodiment of the invention the film has a weight of between 17 g/m² (0.5 oz/yd²) and 102 g/m² (3.0 oz/yd²).

According to another embodiment of the invention the film contains at least 80 percent by weight PET.

According to nother embodiments of the invention, the film is adapted for sealing closed a food container opening or a container medical products.

### BRIEF DESCRIPTION OF THE DRAWING

FIG. 1 is a perspective view of a food or medical container covered with a microperforated film.

### DETAILED DESCRIPTION OF THE INVENTION AND BEST MODE

In accordance with the invention, the preferred film materials are polypropylene (PP), polyethylene (PE), polyethylene terephthalate (PET), nylon 6 (N6) or nylon 6,6 (N6,6). Other films such as polytetrafluoroethylene (PTFE), polyvinylfluoride (PVF), polyvinylchloride (PVC), polyvinylidenefluoride (PVDF), or polyvinylidenechloride (PVDC) can be used as well in this embodiment. Films formed by casting, extrusion or any process are acceptable. Perforations in the form of slits or holes in the film provide air permeability, while the inherent strength and heat stability of the film component provides the necessary characteristics of a food package. The preferred method of film perforation is mechanical perforation, whereby slits or holes are cut through the film. Other methods of perforation, such as laser and electrostatic penetration of the film are also contemplated. The weight of the film preferably ranges from 0.5 oz/yd² (17 grams/m²) to 3.0 oz/yd² (102 grams/m²) as desired for strength properties of the film when used for “lidding” containers such as food or medical containers.

In a preferred embodiment, the lidding film of the present invention comprises at least about 80 wt % PET, more preferably at least about 90 wt % PET. The PET can be a homopolymer or copolymer of PET. A PET homopolymer is intended to mean a polymer substantially derived from the polymerization of ethylene glycol with terephthalic acid, or alternatively, derived from the ester forming equivalents thereof (e.g., any reactants which can be polymerized to ultimately provide a polymer of polyethylene terephthalate). A copolymer of PET is intended to mean any polymer comprising (or derived from) at least about 50 mole percent ethylene terephthalate, and the remainder of the polymer being derived from monomers other than terephthalic acid and ethylene glycol (or their ester forming equivalents).

The film materials are typically designed to exhibit high strength and flexibility, good dimensional stability and excellent chemical resistance. The films are also typically designed to have the ability to heat-seal to themselves or to PET/PE coated paperboard, CPET, APET food trays, polycarbonate, polyamide or other suitable food container compositions. The heat sealable side must be compatible for direct food contact applications subject to limitations found in 21 CFR 177.1630 and in accordance with good manufacturing practices. Typical heat-seal adhesives are based on terpene resin and/or vinyl acetate, but are not limited to these chemistries. While the food container construction is proposed by standard heat-seal manufacturing procedures, it should be understood that the present invention container construction can be sealed using any known techniques, including heat seal, thermal bonding and sonic sealing.

The essential functionality of the present invention is offered by utilizing microperforated holes or slits of smaller dimensions of those identified in prior art. It has been found that the micro dimensions of these orifices combined with a hydrophobic film will not routinely pass liquid in food at ambient or lower temperatures during the normal handling of the food package. Films which contain slits of smaller proportions (1-100 mils in length) are capable of adequately venting steam from food containers when heated by simply increasing the frequency of slits in the film as the port size becomes smaller.

It has also been found that a perforated hole will not routinely pass liquid through a hydrophobic film during normal handling if the holes are less than 5 mils in diameter. There are two possible constructions of this perforated film which exhibit liquid retention while permitting gas/vapor venting though the web:

The film is microperforated as the last process step prior to tray top sealing, or the film is microperforated then coated with adhesive prior to tray top sealing.

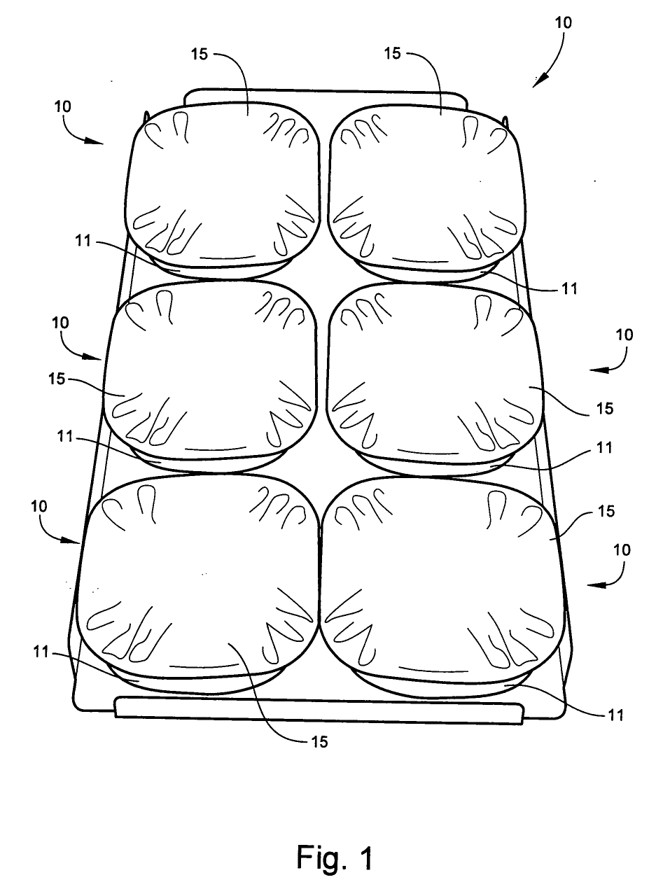

The present invention is applicable to the sealing/lidding of containers for foodstuffs as is shown in FIG. 1. The lidded containers 10 comprise conventional tray containers 11, the contents of which are sealed using a film 15 of the type disclosed in this application. The variety of products with which the design of the present invention could be used is infinite. For example, and in no way intending to limit the scope of the present invention, a film according to the present invention can be used to provide packaging for assorted materials. The container can be used in areas where moisture vapor transmission or gas transmission is crucial or critical when heat energy is applied to the contents.

The following examples set forth embodiments of the method by which the formulation of the present invention can be produced and films thus produced:

### EXAMPLE 1

A 48 gauge PET film with a XM208 vinyl acetate adhesive for heat-seal bonding was obtained from DuPont Teijin Films. The film was mechanical perforated with holes ranging from 3 mil diameter up to 28 mil diameter. The frequency of holes per square inch of film lidding are adjusted to provide approximately 20 mil squared of open orifice area. The perforated film was then attached to a container which provided 1 inch of static water head when inverted. Leakage performance observations follow:

| Hole Diameter | Water Leakage |
|---|---|
| (mil) | (Observed) |
| 3 | None |
| 5 | None |
| 8 | Weeping |
| 11 | Weeping |
| 15 | Dripping |
| 20 | Dripping |
| 28 | Running Drips |

### EXAMPLE 2

A 48 gauge PET film with a XM208 vinyl acetate adhesive for heat-seal bonding was obtained from DuPont Teijin Films. The film was mechanically perforated with slits ranging from 40 mil length up to 200 mil in length. The frequency of slits per square inch of film lidding were adjusted to provide approximately 20 mil squared of open orifice area. The perforated film was then attached to a container which provided 1 inch of static water head when inverted. Leakage performance observations follow:

| Slit Length | Water Leakage |
|---|---|
| (mil) | (Observed) |
| 40 | None |
| 60 | None |
| 80 | None |
| 100 | Weeping |
| 150 | Dripping |
| 200 | Running Drips |

### EXAMPLE 3

A 48 gauge PET film with a XM208 vinyl acetate adhesive for heat-seal bonding was obtained from DuPont Teijin Films. The film was mechanical perforated with slits 60-80 mil length. The frequency of slits per square inch of film lidding are adjusted to provide approximately 20 mil squared of open orifice area. The perforated film was then laminated it to a 7.5″×5.25″ CPET tray which provided 1 inch of static water head when inverted. The sealing of the tray is checked by turning it sideways on each side to look for water leaks. Turning the tray upside down produces absolutely no water weeping through the lidding. The tray was then placed in a 1200 watt microwave and heated on high for 1.5 minutes. The water boiled and vented with a slight swell in the top lidding. Upon removal of the tray from the microwave and subsequent cooling, the vinyl acetate adhesive on the lidding actually resealed the slits and the inside of the container underwent vacuum. The tray was heated and cooled 5 times with the same results.

In general, the range of open area should be between approximately 20-200 mils² per in.², or approximately 0.02 to 0.2 percent open area for most applications.

A process for perforating film and a perforated film product is disclosed above. Various details of the invention may be changed without departing from its scope.

Furthermore, the foregoing description of the preferred embodiment of the invention and the best mode for practicing the invention are provided for the purpose of illustration only and not for the purpose of limitation—the invention being defined by the claims.

We claim:

1. A process of forming a perforated packaging film with simultaneous liquid retention and gas/vapor venting characteristics, comprising the steps of:
(a) forming a polyolefin film;
(b) perforating the film with perforations selected from the group of perforations consisting of slits having a length of no more than 100 mils and holes having a diameter of no more than about 5 mils; and
(c) spacing the perforations from each other so that the total open orifice area is no greater than 20 mils/in².

2. A process according to claim 1, wherein the film is selected from the group of polyolefins consisting of polypropylene (PP), polyethylene (PE), polyethylene terephthalate (PET), nylon 6 (N6), nylon 66 (N6,6), polytetrafluoroethylene (PTFE), polyvinylfluoride (PVF), polyvinylchloride (PVC), polyvinylidenefluoride (PVDF), and polyvinylidenechluoride (PVDC).

3. A process according to claim 1, and including the step of coating the film with an adhesive layer after the film is perforated.

4. A process according to claim 1, and including the step of coating the film with an adhesive layer before the film is perforated, and including the step of perforating the film and the adhesive layer.

5. A process according to claim 4, wherein the adhesive is a hot melt adhesive.

6. A process according to claim 1, 2, 3, 4 or 5, wherein the film has a weight of between 17 g/m² (0.5 oz/yd²) and 102 g/m² (3.0 oz/yd²).

7. A process according to claim 6, wherein the film contains at least 80 percent by weight PET.

8. A perforated packaging film with simultaneous liquid retention and gas/vapor venting characteristics, comprising a polyolefin film having perforations selected from the group of perforations consisting of slits having a length of no more than 100 mils and holes having a diameter of no more than about 5 mils, wherein the perforations are spaced from each other so that the total open orifice area is no greater than 20 mils/in².

9. A packaging film according to claim 8, wherein the film is selected from the group of polyolefins consisting of polypropylene (PP), polyethylene (PE), polyethylene terephthalate (PET), nylon 6 (N6), nylon 66 (N6,6), polytetrafluoroethylene (PTFE), polyvinylfluoride (PVF), polyvinylchloride (PVC), polyvinylidenefluoride (PVDF), and polyvinylidenechluoride (PVDC).

10. A packaging film according to claim 8, and including an adhesive layer applied to the film.

11. A packaging film according to claim 10, wherein the adhesive is a hot melt adhesive.

12. A packaging film according to claim 8, 9, 10 or 11, wherein the film has a weight of between 17 g/m² (0.5 oz/yd²) and 102 g/m² (3.0 oz/yd²).

13. A packaging film according to claim 8, wherein the film contains at least 80 percent by weight PET.

14. A packaging film according to claim 8 and adapted for sealing closed a food container opening.

15. A packaging film according to claim 8 and adapted for sealing closed a container medical products.
